(19) United States
(12) Patent Application Publication
(10) Pub. No.: US 2016/0025850 A1
(43) Pub. Date: Jan. 28, 2016

(54) Autonomous Robotic Mobile Threat Security System

(71) Applicant: Watchstander, LLC, Fort Lauderdale, FL (US)

(72) Inventors: David Andrews Rigsby, Fairfax, VA (US); Robert Allen Touchton, State College, PA (US); Curtis Hugh Walker, State College, PA (US); Scott David Hanford, Port Matilda, PA (US); Thomas William Hilands, State College, PA (US); Donovan Scott Neal, Port Matilda, PA (US)

(21) Appl. No.: 14/459,026

(22) Filed: Aug. 13, 2014

Related U.S. Application Data
(60) Provisional application No. 62/007,251, filed on Jun. 3, 2014.

(51) Int. Cl. G01S 13/88; G01S 7/35; B25J 5/00; B25J 9/16; B25J 13/00; G01S 13/62; G01S 13/72

(52) U.S. Cl. CPC G01S 13/881; G01S 13/62; G01S 7/35; G01S 13/72; B25J 9/1694; B25J 9/1664; B25J 13/00; B25J 5/00; Y10S 901/01

(57) ABSTRACT

A system for providing autonomous robotic mobile threat security is disclosed. The system may perform an operation that includes receiving sensor information associated with an environment surrounding an object, such as a maritime vessel, where the sensor information is associated with a contact. The system may transform the contact information into track data corresponding to a track associated with the contact. Additionally, the system may compute, based on the track data, a confidence level for the track. The confidence level can indicate a representation of the degree to which a threatening behavior is exhibited by the contact as indicated by the track. The system may then determine if the confidence level for the track is at least as great as a threshold confidence level. If the confidence level is determined to be at least as great as the threshold confidence level, the system may classify the track as a threat. Finally, the system may employ a countermeasure against the threat.

### CROSS REFERENCE TO RELATED APPLICATIONS

This patent application claims the benefit of U.S. Provisional Patent Application No. 62/007,251, filed Jun. 3, 2014, which is incorporated by reference in its entirety.

### FIELD OF THE INVENTION

The present application relates to threat detection and identification, security systems, and countermeasure systems, and, more particularly, to an autonomous robotic mobile threat security system.

### BACKGROUND

There are many physical security problems that require the identification of potentially hostile mobile contacts from a background of non-hostile contacts. One such problem is faced in the commercial maritime industry of piracy. In particular, modern piracy and sea-based crime bleeds billions of dollars out of the international marine industry a year. Additionally, people are often killed, held captive, and only returned for ransom. Furthermore, vessels are attacked, hijacked, held, ransomed, or, in some cases, sold. Vessel schedules are wrecked and lives are often destroyed.

Solutions to countering piracy to date have been the same as those of the 18^{th} Century: limited national naval engagement and armed guards on merchant ships. Attempts at developing modern technological countermeasures to piracy tend to be unitary and non-integrated such as razor wire and loudhailers pressed into anti-pirate security. Generally, they all require human identification of the threat and human operation of the countermeasures. Thus they bring with them the requirement for additional crew to operate and maintain them, the exposure of the operator to attack, and the limited range of unaided human perception.

The use of armed teams has had an impact on successful piracy attacks in some regions, but varying national and international constraints make security guards effective only at close ranges. Most armed security teams are only allowed in the high-risk area (HRA) off the coast of Somalia. Yet attacks not only continue there but also are spreading throughout the globe. Attacks in the Gulf of Guinea, the Malacca Straits, and many other areas continue and some would argue increasing. Attacks occur not just on the high seas, but at anchor, drifting and on non-mobile installations such as oil platforms.

Among the problems facing the maritime industry in solving these crimes are the difficulty in determining which craft around them are pirates and which are just normal fishermen and small traders plying their trade. Generally the ranges at which this is currently possible are very short and if the hostile craft is moving at high speed the time to react is very short.

There is an immediate and fundamental need for an autonomous, integrated system that smoothly detects and identifies pirates while engaging them with a graduated response beginning with deterrence and ending in effective disruption of the pirates' ability to conduct a successful attack.

The range at which pirates are identified from among other traffic must be increased to improve reaction time and support more effective deterrence. Increasingly, there is a need for incontrovertible proof that pirates were identified as such before lethal or non-lethal responses were applied.

Crime and piracy on the seas and oceans present a number of problems to improving the security environment. Among the basic needs of the maritime industry to get to a greatly improved security environment are:

Capability to reliably identify hostile contacts even in the presence of non-hostile contacts,

Capability to achieve this identification at sufficient range to provide time for effective deterrence and disruption of the attack,

Ability to quickly apply countermeasures and

Provision for collection of evidence on the attack,

All performed in a fully automated fashion while providing a suitable human interface that allows for a flexible degree of human control and involvement.

The current field of technologies applied to the problem of autonomous identification of hostile mobile targets among non-hostile contacts is effectively non-existent in the civilian sector. Human directed lethal force, always a last resort, is dependent on correct assessment of the level of threat. The potential for the loss of life and property must be sufficiently high to authorize the use of deadly force. Generally, even warning shots are not fired until threats are within 400 meters in civilian defense situations. As noted above, this is 18^{th} Century tactics with more modern weapons.

In fact, currently simply detecting, let alone identifying the potentially hostile threats, is difficult. In the piracy example, the process is dependent on human evaluation of generally imperfect sensor input. Modern ship's radars are extremely powerful, which is good for monitoring contacts at longer ranges but still not reliably effective against low metal content contacts (such as fiberglass and wood) at ranges within a few miles of the radar. This inability to see wood or fiberglass boats has left most vessels dependent on human observation, usually aided only with binoculars.

Currently if a contact is detected, the determination of its hostile intent rests solely with the human observer. This is essentially unchanged since the beginning of seafaring. As yet there has been no effective application of an autonomous robotic security system to the problems facing the civilian environment.

There are multiple problems associated with identification of potentially hostile contacts within an environment of similar mobile, but non-hostile contacts. A system that can sense multiple contacts and then evaluate their behaviors can determine which contact's behavior is potentially hostile and can then utilize countermeasures carried by a variety of actuators to deter or disrupt an attack by the threat.

A maritime version of the autonomous robotic mobile threat security system would eliminate or moderate the above issues, including ineffectiveness of detecting fiberglass or wooden boats, reliance on fallible human observation, and reliance on lethal measures to provide warnings.

### SUMMARY

In order to produce a viable solution aimed at deterring maritime piracy, a fully automated system that detects, identifies, tracks, and prioritizes threatening activities based on contacts reported by a sensor capable of detecting non-metallic boats, such as boats primarily constructed of wood, rubber, fiberglass, is described herein. In particular, a low-cost, commercial-grade FMCW (Frequency Modulation, Continuous Wave) radar (such as the SIMRAD 4G) can be provided as the contact sensor, however, other sensors and sensing technologies may be utilized.

The requirements for the software algorithms included fully autonomous operation, low probability of false alarm, high probability of threat identification and an easily understood interface for human interaction when needed. After summarizing the capabilities of the radar, the disclosure herein describes the algorithms used for automatically forming tracks, removing clutter and tracks that could not represent vessels, and assessing the behavior of each remaining track over time to determine the likelihood that a track is a threat, such as a track involving a vessel operated by pirates. These algorithms are organized as multiple processing steps that include radar raw image processing, contact cluster formation, cluster analysis/track formation, merging of new clusters with existing tracks, and track analysis/threat identification and prioritization.

The system may be used to remove the element of surprise, thus discouraging continuing pursuit of an act of piracy or other types of threats, such as collision threats. The system can use a low cost radar and advanced processing techniques for automatically detecting and tracking threats. This cost effective approach enables anti-piracy capability and anti-collision capabilities to be affordable to a larger percentage of ship owners and operators.

The Autonomous Robotic Mobile Threat Security System provides a robotic, autonomous, integrated system that smoothly detects and identifies threats while simultaneously engaging them with a graduated response beginning with deterrence and ending in effective disruption of the ability to conduct a successful attack.

The system takes advantage of recent advances in radar sensors that provide greater detection capability for non-metallic vessels at greater ranges. In the pirate example, the vessel is almost exclusively comprised of wood or fiberglass. These are also the materials that most small fishing boats and other small boats are made of. However, the problem at hand goes beyond detecting the vessel to determining which contacts are most likely to be a threat and then applying non-lethal countermeasures to them. The automatic identification process and the automatic response process allows for the system to apply countermeasures in a relatively short time and to threats traveling at high rates and within short distances.

The system with detection, identification and countermeasures includes a robotic system suitable for the marine security sector that would collect contact information on the surrounding environment, build behavior records of the contacts in that environment, evaluate their behaviors to determine which contacts were most likely to be threatening and to automatically apply non-lethal countermeasures to the identified probably threatening contacts. If the threat is of a hostile nature, the intent is to either deter the attack, or if the attacker continues, to disrupt the attacker's capability to conduct a successful attack. If the threat is of an accidental nature, the system can warn the pilot or driver of the vessel of an imminent danger. Such a robotic system could also generate both contact sensor and video records of the attack. These records provide necessary evidence for any possible board of inquiry or trial resulting from the incident as well as case studies for training and analysis.

The system can distinguish between certain observable behaviors that are required in order to be a successful pirate and those non-pirate behaviors, such as fishing or in-lane navigation. The disclosed system determines which vessels are likely to be pirate vessels based on their behaviors as observed with long-range sensors such as radar. Thus, the system provides an integrated solution. As such, the system significantly shifts the advantage to the vessels it protects by: detecting and identifying pirate vessels at ranges of at least 2 statute miles (1.8 nm) and farther, such as out to the horizon; deterring attacks by signaling to pirates that they have been detected, and their element of surprise has been lost, and they are being tracked in real time; disrupting the pirates' ability to conduct successful attacks; providing increased reaction time for evasive maneuvers and preparation for a crew response; and documenting the entire engagement both for legal action, analysis and training.

Once the pirate threat has been identified, whether automatically by the system or by user intervention via the user interface, the disclosed system uses a mixed suite of non-lethal countermeasures to engage it. The countermeasure response can be graduated, with the impact on the threat increasing as the range to the protected vessel closes. This entire engagement operation can be fully automated.

The disclosed system is comprised of one or more instances of four subsystems: a sensor suite, a system core, a countermeasure suite, and a user interface. The subsystems can be hardware, software or combinations of both. FIG. 1 provides a schematic of how these subsystems and devices are interconnected in an embodiment possessing one of each subsystem. In some embodiments, the disclosed system may operate in a purely alerting mode whereby the countermeasure suite is not included with the system and all responses are in the form of data output sent to other computer systems, humans or both. Yet other embodiments may operate in an information systems mode whereby neither the sensor suite nor the countermeasure suite are included with the system and all input data is provided by other computer systems and humans and all responses are in the form of data output sent to other computer systems, humans or both. Still further, subsystems can be included by not used or activated. These subsystems are described below.

Sensor Suite.

The sensor suite detects contact and ownship motion and location data and provides that information in a format usable by the System Core. In one embodiment, the contact data is sensed by a radar (for example, a SIMRAD 4G solid state radar) and the motion data is sensed by a 6 degree of freedom, GPS-aided Inertial Measurement Unit (for example, an XSENS MTi G).

System Core.

The Core provides the processing of the robotic system and is composed of a Data Processing and Track Processing component, which is tasked with preparing and evaluating sensor data to determine which contacts are Tracks and estimating the parameters of each Track, and an Intelligent Controller (IC) component. The IC is further divided into several sub-components. One subcomponent is the Perception Engine, which is tasked with estimating the degree to which the behavior of each track is consistent with one or more threatening behaviors such as those used during or before a pirate attack or other threatening behavior, such as an accidental collision course, and the Response Engine, which is tasked with controlling and managing the devices of the Countermeasure Suite. In one embodiment, the System Core runs under Windows on readily available PCs, but software elements disclosed herein can run under any modern operating system on any modern computing platform.

Countermeasure Suite.

The Countermeasure Suite uses one or more countermeasure devices to strip attacker(s) of the element of surprise or the cover of darkness, to degrade their capability to conduct a successful attack or to warn off a non-hostile threat. It also includes a video capture device to provide situational awareness to the system users as well as for archival purposes. These devices can be mounted on a Pan-Tilt Unit (PTU) to enable the System Core to point the countermeasure and video devices towards the threat. While this is occurring, the system data and video associated with the threat can be fully archived. All countermeasures employed in the system can be non-lethal. For example, in one embodiment, the system can use a Peak Beam Maxa Beam strobing searchlight as its countermeasure and an AXIS P1355-E outdoor Ethernet camera as its video capture device, both of which can be mounted on a FLIR Motion Controls D100E PTU.

User Interface.

The User Interface (UI) can provide users with a view of the sensed contact data with System Core interpretation and response findings superimposed over it. The UI can also provide the range, bearing, speed, heading, and threat likelihood of each track. The UI can also repeat the video being captured by the camera. The UI also allows the user to escalate and deescalate Tracks and to set certain countermeasure parameters, such as the threat range at which the spotlight switches from continuous to strobe mode.

In one embodiment, an autonomous robotic mobile threat security system is disclosed. The system may include a memory that stores instructions and a processor that executes the instructions to perform various operations of the system. The system may perform an operation that includes receiving information associated with an environment surrounding an object. The information may be associated with a contact in the environment. Additionally, the system may perform an operation that includes transforming the information into track data corresponding to a track associated with the contact. Also, the system may perform an operation that includes computing, based on the track data, a confidence level for whether the contact represented by the track is exhibiting one or more threatening behaviors. The system may then perform an operation that includes determining if the confidence level of a given threat for a given track is at least as great as a threshold confidence level. If the track's confidence level is determined to be at least as great as the threshold confidence level, the system may perform an operation that includes classifying the track as a threat. Finally, the system may perform an operation that includes employing one or more countermeasures against the threat.

In another embodiment, a method for providing autonomous robotic mobile threat security is disclosed. The method may include utilizing a memory that stores instructions, and a processor that executes the instructions to perform the various functions of the method. The method may include receiving information associated with an environment surrounding an object, wherein the information is associated with a contact in the environment. Additionally, the method may include transforming the information into track data corresponding to a track associated with the contact. The method may also include computing, based on the track data, a confidence level for the track. The confidence level may indicate a level of one or more threatening behaviors exhibited by the contact. The method may further include determining if the confidence level of a given threat for a given track is at least as great as a threshold confidence level. If the confidence level for the track is at least as great as a threshold confidence level, the method may include classifying the track as a threat. Finally, the method may include employing a countermeasure against the threat.

According to yet another embodiment, a computer-readable device having instructions for providing autonomous robotic mobile threat security is provided. The computer instructions, which when loaded and executed by a processor, may cause the processor to perform operations including: receiving contact information associated with an environment surrounding an object, wherein the contact information is associated with a contact; transforming the contact information into track data corresponding to a track associated with the contact; computing, based on the track data, a confidence level for the track, wherein the confidence level indicates a level of one or more threatening behaviors exhibited by the contact; determining if the confidence level of a given threat for a given track is at least as great as a threshold confidence level; classifying the track as a threat if the confidence level is determined to be at least as great as a threshold confidence level; and possibly employing a countermeasure against the threat.

These and other features of the systems and methods for providing autonomous robotic mobile threat security are described in the following detailed description, drawings, and appended claims.

### BRIEF DESCRIPTION OF THE DRAWINGS

FIG. 1 is a schematic diagram of an autonomous robotic mobile threat security system according to an embodiment of the present disclosure.

FIG. 2 is a component interconnection diagram of a sample implementation of the autonomous robotic mobile threat security system of FIG. 1 that incorporates port and starboard instances of the Sensor Suite, System Core, and Countermeasure Suite with a single User Interface.

FIG. 3 is a flow diagram illustrating a multi-target tracking process used for transforming contact data into legitimate tracks according to the present disclosure.

FIG. 4 is a flow diagram illustrating an interacting maneuvering model algorithm for tracking contacts according to the present disclosure.

FIG. 5 is a user interface layout diagram illustrating a sample implementation of a user interface for use with the system of FIG. 2.

FIG. 6 is a flow diagram illustrating a sample method for providing an autonomous robotic mobile threat security capability to an embodiment of the present disclosure.

FIG. 7 is a schematic diagram of a machine in the form of a computer system within which a set of instructions, when executed, may cause the machine to perform any one or more of the methodologies or operations of the systems and methods for providing autonomous robotic mobile threat security.

### DETAILED DESCRIPTION OF THE INVENTION

The autonomous robotic mobile threat security system 100 greatly enhances the capability of a civilian vessel to detect, avoid, deter or disrupt an attack or even accidental collision without immediate resort to lethal means. The system 100 protects lives and property in an environment where it is often difficult to determine which contacts are hostile and which are not. The invention preserves the life not only of the crew protected by this system but also the life of the attackers who are deterred from an encounter with lethal force. The autonomous robotic mobile threat security system 100 provides for identification of hostile targets at greater ranges and time factors than current systems, and protects the lives of both protected and attacker.

The autonomous mobile threat security system 100 according to the present disclosure: can use radar 102, such as a Frequency Modulation Continuous Wave (FMCW) radar, pulse radar or Light Detection And Ranging (LIDAR) radar, to obtain contact information about its surrounding environment. The system 100 can also use electro-optical devices, such as a cameras, to obtain contact information about the surrounding environment. can The system 100 can also transform the contact data into track data (such as range, bearing, speed, heading, closest point of approach and time to closest point of approach) in an analyzable format; can analyze the track data to classify which contacts are exhibiting threatening behaviors by can compute the level of confidence that each tracked contact is a threat; can test the confidence level of each track for each threatening behavior against a threshold confidence level assigned for each threatening behavior and can classify those that exceed that threshold as a Threat; can automatically select, energize and apply effective, non-lethal countermeasures to those tracks classified as a Threat, including automatic operation of the countermeasure (e.g., causing the spotlight used in one embodiment to strobe when the Threat comes within a pre-specified range of the protected ship); can deter or disrupt a Threat's ability to conduct a successful attack; can compute the necessary movement of the pan-tilt unit to keep the Threat in view; can convert those movements into instructions understood by the pan-tilt unit; and/or can send the instructions to the pan-tilt unit (thus causing the countermeasures to “follow” the Threat”). In parallel, the system can notify the crew and build a radar data and video recording archive (e.g. using database 155) of the engagement for evidence, analysis and/or training.

In cases where there are more than one threat in view of a countermeasure suite, the system 100 can sort the threats by confidence level and direct its response towards the threat with the highest confidence level, with hysteresis to avoid thrashing between threats with almost identical confidence levels.

The system also provides a graphical user interface, such as interface 132, that informs users of current tracks and threats, shows video feeds from countermeasure suites, and provides system and device status information without any dependence on having a human user viewing the user interface, such as via a monitor, terminal, console or other similar device, (i.e., fully autonomous operation unless a human user elects to interact with the system). The graphical user interface, such as interface 132, can also allow a user to easily alter the configuration and performance of the system, although some parameter changes can require a password authentication. The graphical user interface, such as interface 132, can also allow a human user to easily upgrade an ordinary track to a threat, after which the track will be treated like a threat, or downgrade a system-determined threat to an ordinary track, after which it will be treated as a non-threatening track. The system 100 can also provide automated system health monitoring, alerting and recovery. For instance, faults and failed network connections can be discovered, brought to the attention of human users, and for many cases, diagnosed and corrected by the system software.

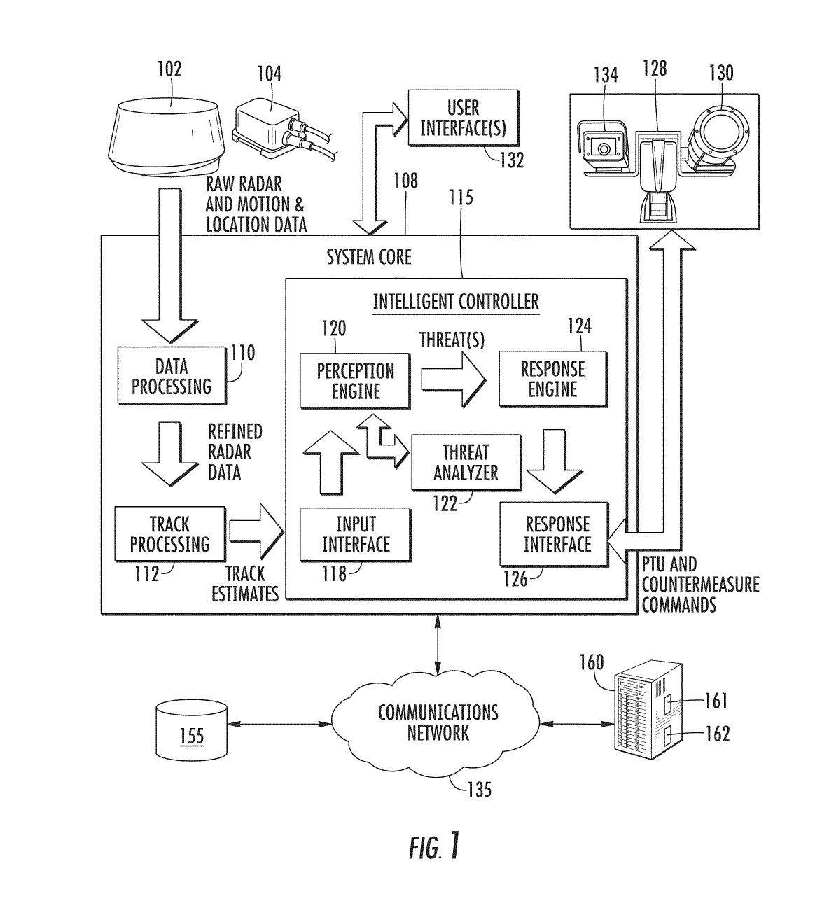

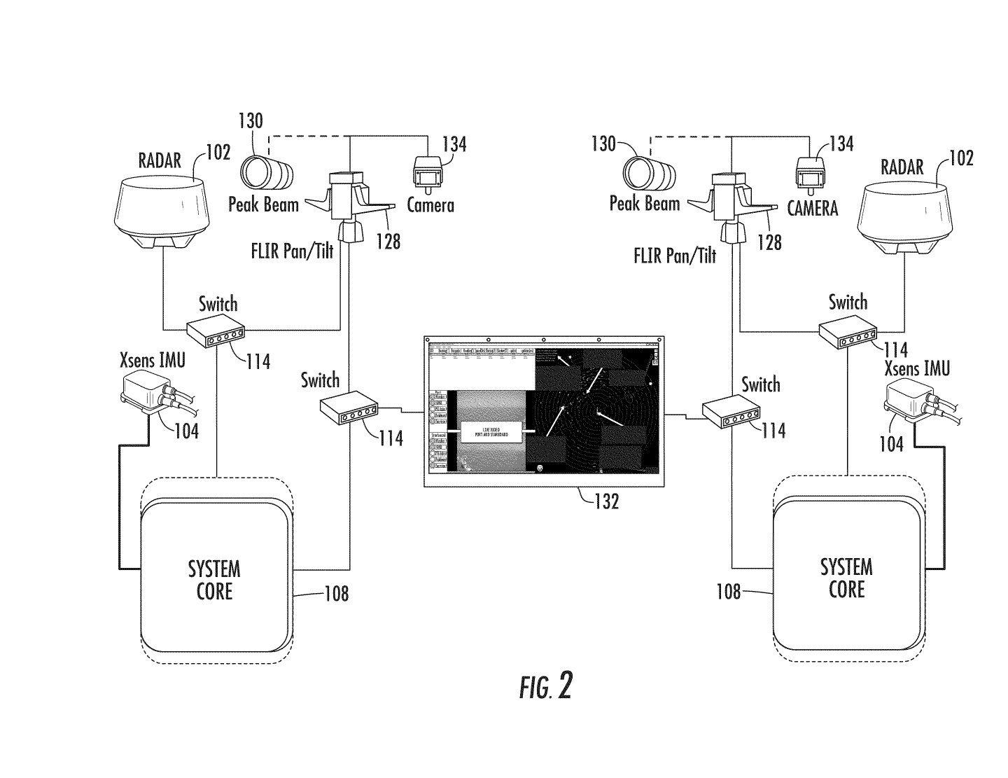

Referring to the drawings, and in particular, FIGS. 1 and 2, the disclosed system 100 is comprised of one or more instances of four subsystems: a sensor suite (102 and 104), a system core (108), a countermeasure suite (128, 120 and 134), and a user interface, such as interface 132. FIG. 1 provides a schematic of how these subsystems and devices are interconnected and FIG. 2 provides a component interconnection diagram based on a sample implementation of the system 100 on a maritime vessel.

Sensor Suite.

The sensor suite can detect radar contacts, or other surrounding contacts depending on the type of sensor employed, and ownship motion and location data and can provide that information in a format usable by the Core. The radar 102, for example, can be a SIMRAD 4G solid state radar and the motion sensor 104, for example, can be an XSENS MTi G. The data provided by the motion sensor 104, which can provide ownship motion, speed, orientation and location data, and the response and closed-loop control of the countermeasure suite, including ownship motion stabilization, may be utilized to perform a variety of functions.

System Core.

The core 108 can be responsible for processing of the system and may be composed of a data processing module 110, which can convert native sensor data formats into standardized system data formats, a track processing module 112, which can evaluate contact sensor data to determine which contacts are tracks and estimating the parameters of each track, and an intelligent controller (IC) component 115.

The IC 115 can be further divided into several sub-components, including: perception engine 120, which can manage the analysis of multiple tracks being assessed for multiple threatening behaviors; threat analyzer 122, which can estimate the degree to which the behavior of each track is consistent with that of a threatening behavior; and response engine 124, which can control and manage the countermeasure suite. The IC 115 also may include an input interface 118, which can manage the input of any number of tracks along with ownship and other data into the IC and response interface 126 that manages and formats the commands to and reports from the various countermeasure devices. The core 108 may run under Windows on readily available PCs or on other operating systems and computing devices.

Countermeasure Suite.

The countermeasure suite can use a mix of video capture and countermeasure devices to strip attacker(s) of the element of surprise or the cover of darkness. It can also degrade their capability to conduct a successful attack. Alternatively, it can warn an inattentive pilot of an impending collision, or ward off any contact exhibiting any other threatening behavior, which can be included as one or models of such threatening behaviors. These devices can be mounted on a pan-tilt device 128, such as a FLIR Motion Control D100E Pan-Tilt Unit (PTU). Additionally, the system data and video associated with the attack may be fully archived, such as in database 155. The system 100 can use an AXIS P1355-E camera 134 or other camera. Countermeasures employed in the system 100 can be non-lethal, such as a Peak Beam Maxa Beam strobing searchlight 130, or other searchlight.

User Interface.

The user interface, such as interface 132 shown in FIGS. 1, 2, and 5, provides users with a view of the radar contact data with system core interpretation and response findings superimposed over it. The display also provides the range, bearing, speed, heading, and threat likelihood of each track. The display can also repeat the video being captured by the Camera. The display can also allow the user to escalate and deescalate Tracks and to set certain countermeasure parameters, such as the threat range at which the spotlight switches from continuous to strobe mode.

With the high-level subsystems described above, the operation of the system 100 as a maritime piracy deterrent can be described as follows.

Step One—Detect and Identify (Evaluation). The disclosed radar-based system is optimized to detect small and low metallic content boats in an open ocean environment. The radar 102 may operate continuously, and at least during transits of high threat areas. All contacts detected by the radar 102 may be evaluated by the core 108 to determine which contacts are tracks that are likely to be maritime objects and of those, which are possibly pirates. The system 100 can operate at approximately 2 nautical miles for detection, but the range may be extended to approximately 5 nautical miles or more.

Radar data is passed to the system core 108 where the data is analyzed by the IC 115 using a pipeline of algorithmic functions as described below that a) removes clutter and noise (e.g., whitecaps or land masses), b) forms and maintains tracks and their characteristics (e.g., range, bearing, speed and heading), and c) evaluates each track over time as to the likelihood that it is exhibiting piracy-related behaviors. If that likelihood exceeds a predefined threshold, it is deemed a threat and its track on the user interface 132 is flagged and turns red.

Step Two—Notify and begin tracking/documentation (Initial Engagement). Once a track has been identified as a likely pirate threat, the system core 108 notifies the fuser interface 132 that a probable pirate has been detected. Simultaneously or contemporaneously therewith, the system core 108 may initiate the ccountermeasure suite operation. The system core 108 can compute the range, reciprocal bearing, and declension angle to the pirate. The system core 108 can then direct the ccountermeasure suite to track the threat and operates the documentation and engagement systems against the threat. Documentation may consist of operating a low-light, long-range capable camera, such as camera 134, against the threat. This may provide incontrovertible evidence of the threat's behavior and level of hostility. The data captured by the camera 134 may be stored onboard, but the data may also be transmitted to a remote ground station.

The system core 108 can also direct a countermeasure system such as a white spotlight 130 or laser to the threat and can track it. The system 100 may also utilize a ruggedized 12 million candlepower white spotlight. The threat may see the light at about 1.6 nautical miles and realize that the light is tracking the threat's movements. This will eliminate any doubt the threat may have that the threat has been detected and the intended victim is alert to the threat's presence and already reacting. Step two also allows the protected vessel to begin evade-and-escape maneuvers.

Step Three—Track and Escalate Engagement. If the pirate is undeterred by the loss of surprise and being confronted with a fully alert victim, the system core 108 can operate the ccountermeasure suite to disrupt the pirate's ability to conduct a successful attack. In the system 100, the spotlight 130 may have a strobing mode that saturates the retina causing temporary black spots in the field of vision. The duration of the spots can be from a few seconds to several minutes. But because the temporary blindness is within the retina, even if the pirate looks away from the light, the pirate will still have impaired vision. The spotlight may also cause the pirate to also experience nausea and disorientation along with the blindness. In certain embodiments, the spotlight 130 countermeasure can be employed at ranges up to approximately 800 meters.

The spotlight 130 is an initial countermeasure, however, additional countermeasures may be utilized, such as, but not limited to, a compressed air launcher for a projectile filled with pepper spray capsules that can currently be used at ranges of 400 meters. Countermeasures may be employed at ranges of up to one kilometer or more. The countermeasures can bring such force short of lethal means that neither training nor fanaticism will enable the pirates to make it through the defenses provided as a part of the system 100. The system 100 can mix and match so a pirate will never know what combination of countermeasures to expect and train for. Meanwhile, the camera 134 can be documenting the increasing use of non-lethal force brought to bear on the pirates before resorting to the use of lethal force by an on-board security team, if one is available.

Step Four—Prioritize Targeting Data for On-Board Security Team. If a security team with lethal means is onboard the protected vessel, the system core 108 can provide them with prioritized targeting data to support the most effective application of lethal force to stop the attack. The documentation component of system 100 will clearly demonstrate that the captain of the protected vessel tried multiple means of non-lethal defense before finally, being in fear for the life of the crew and the safety of the vessel, resorting to the use of lethal force.

Radar Data Processing.

The system 100 may also include a radar, such as a SIMRAD 4G FMCW (Frequency Modulation, Continuous Wave) radar 102. Such a radar can detect non-metallic boats inside of 5 nautical miles. Additionally, this solid state radar has very low emissions (akin to that of a cellular telephone) and is controllable via software using a vendor-supplied software development kit (SDK). Via the SDK, the system is able to programmatically startup and configure the radar, as well as reconfigure it, without placing any demands on the crew thus satisfying the requirement for fully autonomous operation. The radar 102 can be mounted on a vessel at an appropriate height. The radar 102 can also have a number of configurable signal processing algorithms aimed at such things as dealing with weather-related clutter, reducing RF interference, balancing gain to detect weak contacts versus increased false detections, and on the like. Such configurations provide a user display that is as clear and informative as possible. However, for system 100, the data may be analyzed by another computer program, a set of radar parameters can be selected to provide track processing module 112 with the data for performing its duties.

Multi-Target Tracking Approach.

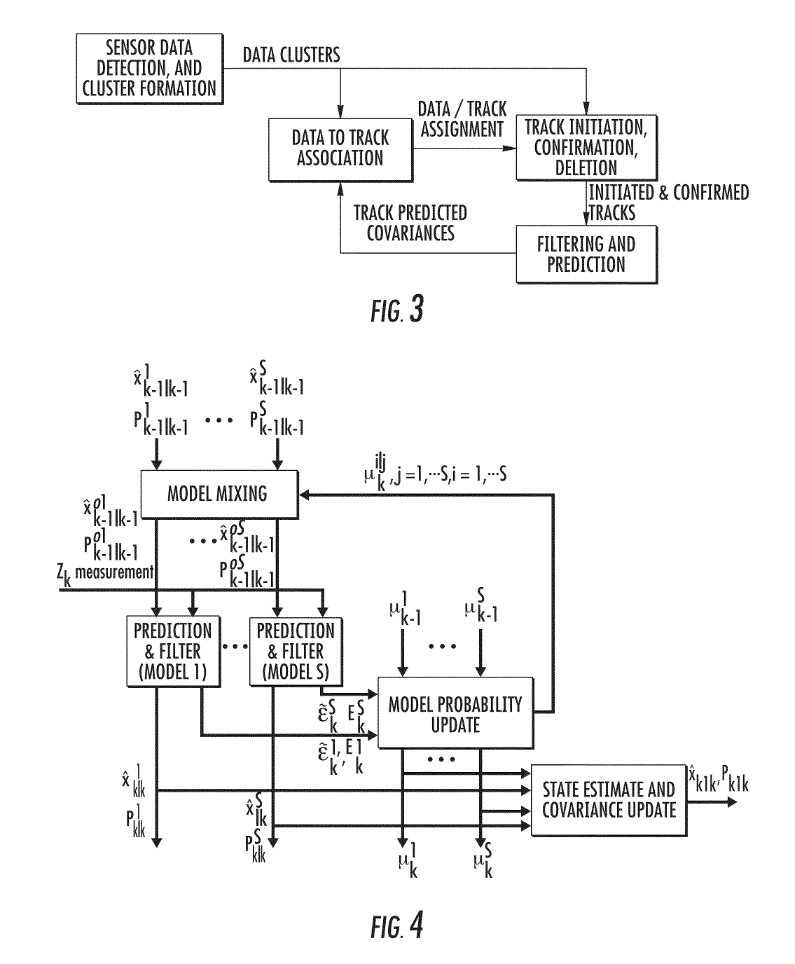

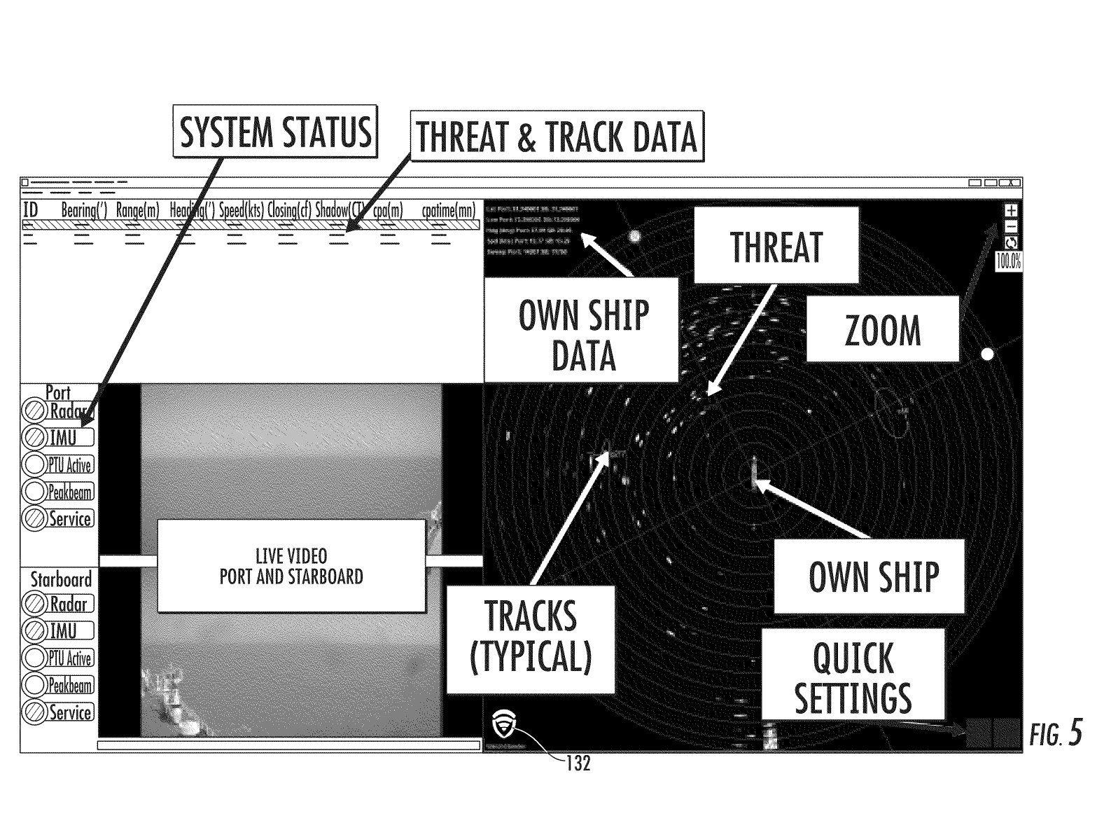

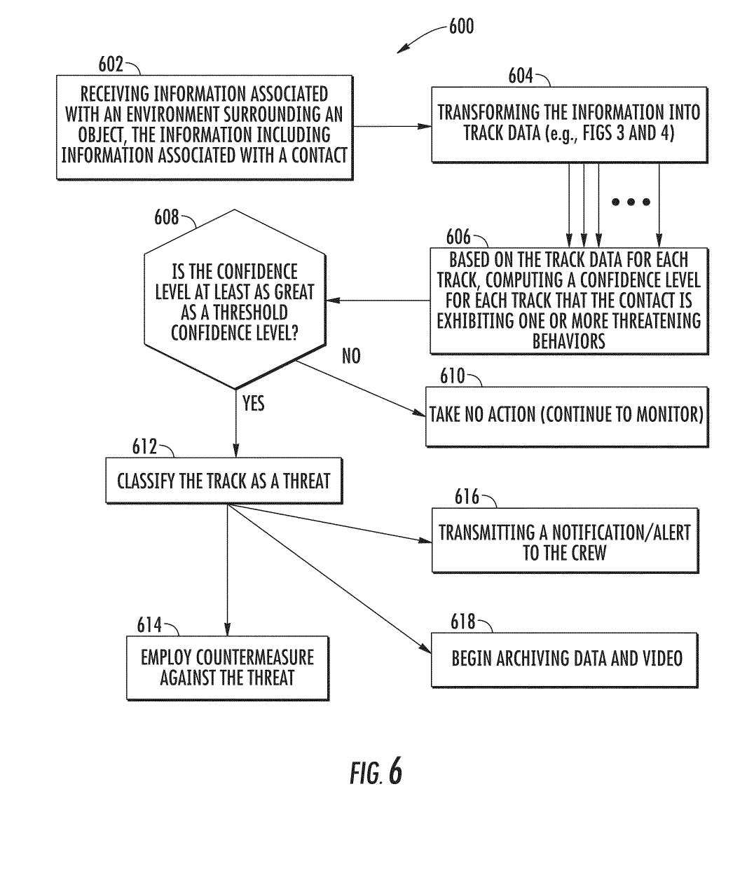

In one embodiment, track processing 112 of system 100 can use a multi-target tracking (MTT) algorithm to track multiple contacts simultaneously. Other tracking algorithms can be used. It will track any objects that have persistence in the sensor data. This includes stationary objects (such as buoys, anchored vessels, etc.) as well as small, highly maneuvering fast boats. It is up to the system threat assessment function of threat analyzer 122 to sort the tracks and to decide the threat status of each track. The MTT algorithm used for system 100 employs an interacting multiple model (IMM) Kalman filter for each track. The IMM offers the capability of tracking highly maneuvering contacts while using straightforward linear Kalman filter equations. Tracking is performed in Cartesian coordinates. A high-level bock diagram of the MTT is shown in FIG. 3.

Detection and Cluster Formation.

The output of the radar 102 is 2048 azimuth spokes of contact data per 360-degree sweep, with each spoke divided into 1024 so-called range bins creating ˜2 million data points every 1.67 seconds when operating at 36 rpm. The radar range scale and many other radar parameters can be adjusted via software. For the disclosed system 100, the maximum data value from each range bin can be taken from azimuths spanning plus or minus a half a degree from the whole degree azimuths by process 110 so that the effective detection data matrix is 360 azimuth bins by 1024 range cells. This technique can increase processing throughput. At a nominal range of 1.8 nautical miles, the range resolution per bin is 3.26 meters. 4-bit data fields represent the data on a scale of 0 to 15. The native software in the SIMRAD 4G performs sophisticated processing to reduce the background noise and enhance detections. The SIMRAD 4G output is signal to noise (SNR) data that has been clipped.

The first step in the system processing is to threshold this data. The threshold is chosen to maximize the response from small boats. The threshold detections can be processed using a sophisticated clustering algorithm to combine the energy from range/azimuth cells. This algorithm clusters data in adjacent and nearly adjacent cells based on range/azimuth proximity. The SNR amplitude is not used in data-to cluster association. The clusters represent packets of energy from a single sweep of the radar. They can be associated with objects such as buoys, ships and land features, or they can be associated with white caps and other irregularities on the ocean surface or even multipath returns from objects. The tracking algorithm can sort this information and form tracks only on objects of interest. The geometric centroid of the data in each cluster is used as the range/azimuth of the cluster. The downstream tracking algorithms may use only this centroid for tracking.

Data to Track Association.

After the clusters are formed, they are individually evaluated to determine if they can be associated with existing tracks. Each track may have a predicted estimate for the track location and the track covariance. This information can be used to create a 2-dimensional prediction region. Any clusters that fall within this region are treated as possible candidates for assignment for the track. After all clusters are evaluated, the cluster with the smallest Euclidean distance to the predicted track position is assigned to the track. In certain embodiments, a single cluster may not be assigned to multiple tracks. If multiple tracks claim the same cluster, that cluster may be assigned to the track whose predicted position has the smallest Euclidean distance to the cluster. The other track(s) are then reevaluated to find the next-closest cluster to the predicted track position if one exists within the covariance boundaries. Once a cluster is associated with a track, it may be eliminated from consideration for other existing tracks or for new tracks.

Track Initiation, Confirmation, Deletion.

Tracks can be assigned with a confirmed status if a cluster was associated with the track in the current sweep. If no cluster is assigned to an existing track, that track may be coasted,’ a term referring to using an estimate of where the track could be if the sensor does not detect any contact data for it during a given sweep. Since the contact state is not updated for coasting tracks, the updated state variables are assigned to the predicted state from the previous sweep. The state covariance will grow on each sweep without an update. A track may be deleted if a cluster has not been associated with the track within the past several sweeps, such as the past 2 to 5 sweeps. For instance, a track may be deleted if a cluster has not been assigned within the past five sweeps, but this is a field-configurable parameter. Any clusters that have not been assigned to an existing track may be eligible for use in new track formation. An evaluation is performed for each unassigned cluster in the current sweep to determine if it can be associated with unassigned clusters in up to N previous sweeps, where N is a field-configurable parameter. For each of these clusters in the current sweep, the range rate and the azimuth rate are computed from that cluster to all unassigned clusters in the previous sweeps. Range rate and azimuth rate are treated separately because azimuth variance is typically much higher than range variance for the SIMRAD 4G radar. A new track is formed if there is a consistent range rate and consistent azimuth rate from the current cluster to at least M clusters in previous sweeps, where M is a field-configurable parameter. All new tracks and confirmed tracks may be passed to the prediction and filtering step for track update and maintenance.

Track Filtering and Prediction.

An interacting maneuvering model (IMM) algorithm may be employed by track processing 112 in the system 100 for tracking each contact. The IMM has the advantage that it has the capability of tracking the most severe contact dynamics. Maneuvers are typically abrupt deviations from constant heading contact motions. This can be especially true for small, fast boats. By using multiple models, representing different contact maneuver trajectories, the filtering operation is allowed to rapidly adapt to abrupt course changes. Multiple maneuver models may be run in parallel. Bayes rule and the filter residuals are used to evaluate the relative validity of each model. The output state estimate is a probability-weighted composite of the multiple models. The IMM may employ soft switching. The state estimate is obtained by a weighted sum of the models (modes) employed. The weights change with time as the contact motion changes, with the dominant model best matching the contact motion, while the other model weights are relatively small.

The IMM processing flow is illustrated in FIG. 4. Prediction and filtering may be performed using standard linear Kalman filters. The variables defined below are used in the algorithm:
\hat{x}_{k|k}^{j}, P_{k|k}^{j}: state estimate and covariance of mode-matched filter j and time k
\hat{x}_{k|k}^{vj}, P_{k|k}: mixed state estimate and covariance of mode-matched filter j and time k
\hat{x}_{k|k}, P_{k|k}: combined state estimate and covariance at time k
μₖ^{i|j}: conditional probability that the contact transitioned from state i to state j at time k
μₖ^{j}: probability that the contact is in mode j after the measurement at time k
Π: Markovian transition probabilities with elements π^{i|j}
∀ₖ^{j}: likelihood function of mode-matched filter j at time k.

State Model. A linear process and measurement model expressed by the standard expressions for state transition Xₖ and measurement zₖ is as follows:

Xₖ=FₖXₖ₋₁+ΓₖVₖ

zₖ=HₖXₖ+ηₖ

where Fₖ is the state transition matrix, uₖ is a control vector, Γₖ is the model applied the process noise Vₖ, zₖ is he measurement vector, Hₖ is the measurement model, and ηₖ is the measurement noise. It is assumed that Vₖ and ηₖ are zero mean Gaussian noise with ηₖ˜N(0, Rₖ) and Vₖ˜N(0, Qₖ).

Model Mixing.

The input to the model-matched filter is a mixture of all of the S model-matched filters. Given filtered model estimates and covariances \hat{x}_{k-1|k-1}^{j}, P_{k-1|k-1}^{j}, and probabilities Π, μₖ₋₁^{j}, μₖ₋₁^{i|j}, the mixed model state vector and covariance estimates are:

$${\hat{x}}_{k - 1 \vert k - 1}^{oj} = {\sum }_{i = 1}^{S} {μ}_{k - 1}^{i \vert j} {\hat{x}}_{k - 1 \vert k - 1}^{j}$$

$${P}_{k - 1 \vert k - 1}^{oj} = {\sum }_{i = 1}^{S} {μ}_{k - 1}^{i \vert j} [ {P}_{k - 1 \vert k - 1}^{i} + ( {\hat{x}}_{k - 1 \vert k - 1}^{j} - {\hat{x}}_{k - 1 \vert k - 1}^{oj} ) {( {\hat{x}}_{k - 1 \vert k - 1}^{j} - {\hat{x}}_{k - 1 \vert k - 1}^{oj} )}^{T} ]$$

State Prediction.

The predicted values for each model at time k are given by:

\hat{x}_{k-1|k-1}^{j}=F^{k}\hat{x}_{k-1|k-1}^{oj}+uₖ

P_{k-1|k-1}^{j}=Fₖ^{j}P_{k-1|k-1}^{oj}Fₖ^{j}^{^{T}}+Γₖ^{j}Qₖ^{j}Γₖ^{j}^{^{T}}

State Update.

The measurement residual is defined as:

\tilde{ε}ₖ^{j}=zₖ−Hₖ^{j}X_{k|k-1}^{j}

The Innovation (or residual) covariance is then:

Eₖ^{j}=Hₖ^{j}P_{k|k-1}^{j}Hₖ^{j}^{^{T}}+Rₖ^{j}

and the optimal Kalman gain is:

Kₖ^{j}=P_{k|k-1}^{j}Hₖ^{j}^{^{T}}Eₖ^{j}^{^{−1}}

Now the updated state and covariances can be obtained as:

\hat{x}_{k|k}^{j}=\hat{x}_{k|k-1}^{j}+Kₖ^{j}\tilde{ε}ₖ^{j}

Pₖ^{j}=(I−Kₖ^{j}Hₖ^{j})P_{k|k-1}^{j}

Model Probability Update.

An assumption is that the residuals are zero mean Gaussian errors such that the likelihood function can be expressed as:

$${A}_{k}^{j} = {\vert 2 π {E}_{k}^{j} \vert}^{- 1 / 2} exp ( - \frac{1}{2} {{\tilde{ɛ}}_{k}^{j} ( {E}_{k}^{j} )}^{- 1 / 2} {E}_{k}^{{j}^{T}} )$$

$$and$$

$${μ}^{j -} = {\sum }_{i = 1}^{S} {π}^{i \vert j} {μ}_{k - 1}^{i} .$$

The updated model probabilities are now:

$${μ}_{k}^{j} = \frac{{Λ}_{k}^{j} {μ}^{j -}}{{\sum }_{i = 1}^{S} {Λ}_{k}^{i} , {μ}^{i -}}$$

$${μ}_{k}^{i \vert j} = \frac{{π}^{i \vert j} {μ}_{k - 1}^{i}}{{μ}^{j -}}$$

State Estimate and Covariance Update.

The models are combined to form the aggregate state estimate as follows

$${\hat{x}}_{k \vert k} {\sum }_{j = 1}^{S} {\hat{x}}_{k \vert k}^{j} {μ}_{k}^{j}$$

$${P}_{k \vert k} = {\sum }_{j = 1}^{S} {μ}_{k}^{j} [ {P}_{k \vert k}^{i} + ( {\hat{x}}_{k \vert k}^{j} - {\hat{x}}_{k \vert k}^{j} ) {( {\hat{x}}_{k \vert k}^{j} - {\hat{x}}_{k \vert k}^{j} )}^{T} ]$$

Initialization. The Markov transition probability matrix reflects the probability of transitioning from one state to another. The transition matrix for the 3-model maneuvering contact may be given by:

$$Π = [ \begin{matrix}0.90 & 0.05 & 0.05 \\ 0.15 & 0.85 & 0 \\ 0.15 & 0 & 0.85\end{matrix} ] .$$

This satisfies intuition in that upon initialization the probability of the CV model transitioning to itself is 0.90, while the probability of the CV model transitioning to either of the CT models is 0.05. The CT models may never transition to each other (probability=0) but they may transition to the CV model (probability=0.15). The initial weight vector is μ₀=[1,0,0].

Maneuver Models. The relative state vector is defined by:

x=x^{t}−x^{s}=[enė\dot{n}]

where e and n represent east and north, x^{t} is the contact state vector and x^{s} is the state vector of ownship, which is obtained from the on-board inertial measurement unit (IMU) 104. The dynamics of the contact may be modeled using multiple switching regimes, known as a jump Markov system. During each observation period, the contact may obey one of three dynamic behavior models: (1) Constant Velocity (CV) model, (2) clockwise coordinated turn (CT) model, and (3) counterclockwise CT model. Let j (j=1,2,3), be the mode variable in effect in the observation interval (k, k+1). Then the contact dynamics can be expressed as:

xₖ₊₁^{j}=ƒ(xₖ^{j},xₖ^{s},xₖ₊₁^{s},j)+Γₖvₖ

For the constant velocity model, the process noise contains only an acceleration component, such that

$${Γ}_{k} = [ \begin{matrix}{T}^{2} / 2 & 0 \\ 0 & {T}^{2} / 2 \\ T & 0 \\ 0 & T\end{matrix} ] ,$$

and vₖ is a 2×1 i.i.d. process noise vector representing random accelerations in the east and north directions with vₖ˜N (O, Qₖ). Use Qₖ=σₐ²1₂, where σₐ is a scalar and 1₂ is a 2×2 identity matrix. Γₖ and vₖ may not dependent on the model j. They may be the same for all three models. The mode-conditioned transfer function f( ) is given by:

ƒ(xₖ^{j},xₖ^{s},xₖ₊₁^{s},j)=Fₖ^{j}·(xₖ^{j}+xₖ^{s})−xₖ₊₁^{s}

where Fₖ^{j} is the state transition matrix corresponding to each of the three modes of the maneuvering contact model. Mode 1 may be defined as the constant velocity model and the state transition model is:

$${F}_{k}^{j} = [ \begin{matrix}1 & 0 & T & 0 \\ 0 & 1 & 0 & T \\ 0 & 0 & 1 & 0 \\ 0 & 0 & 0 & 1\end{matrix} ] ,$$

where T is the time between observations. The state transition matrices corresponding to the clockwise and counter-clockwise coordinated turn models are given as:

$${F}_{k}^{j} = [ \begin{matrix}1 & 0 & \frac{sin ( {Ω}_{k}^{j} T )}{{Ω}_{k}^{j} )} & - \frac{( 1 - cos ( {Ω}_{k}^{j} T ) )}{{Ω}_{k}^{j} )} \\ 0 & 1 & \frac{( 1 - cos ( {Ω}_{k}^{j} T ) )}{{Ω}_{k}^{j} )} & \frac{sin ( {Ω}_{k}^{j} T )}{{Ω}_{k}^{j} )} \\ 0 & 0 & cos ( {Ω}_{k}^{j} T ) & - sin ( {Ω}_{k}^{j} T ) \\ 0 & 0 & sin ( {Ω}_{k}^{j} T ) & cos ( {Ω}_{k}^{j} T )\end{matrix} ] , j = 2 , 3$$

The mode—conditioned turning rates are

$${Ω}_{k}^{2} = \frac{{a}_{m}}{\sqrt{{( {\hat{x}}_{k} + {\hat{x}}_{k}^{s} )}^{2} + {( {\hat{y}}_{k} + {\hat{y}}_{k}^{s} )}^{2}}} , {Ω}_{k}^{3} = \frac{- {a}_{m}}{\sqrt{{( {\hat{x}}_{k} + {\hat{x}}_{k}^{s} )}^{2} + {( {\hat{y}}_{k} + {\hat{y}}_{k}^{s} )}^{2}}}$$

where aₘ is typical value for maneuver acceleration. Tracking in Cartesian coordinates has the advantage of allowing the use of linear contact dynamic models for extrapolation. However, since contact state measurements are made in polar coordinates (rₖ, θₖ), the measurement errors are coupled. The measurements are converted to Cartesian coordinates using

zₖ=[rₖ cos(θₖ),rₖ sin(θₖ)].

The measurement covariance is then:

$${R}_{k} = [ \begin{matrix}{σ}_{{r}_{k}}^{2} {cos}^{2} ( {θ}_{k} ) + {r}_{k}^{2} {sin}^{2} ( {θ}_{k} ) {σ}_{{θ}_{k}}^{2} & \frac{1}{2} sin ( 2 {θ}_{k} ) [ {σ}_{{r}_{k}}^{2} - {r}_{k}^{2} {σ}_{{θ}_{k}}^{2} ] \\ \frac{1}{2} sin ( 2 {θ}_{k} ) [ {σ}_{{r}_{k}}^{2} - {r}_{k}^{2} {σ}_{{θ}_{k}}^{2} ] & {σ}_{{r}_{k}}^{2} {sin}^{2} ( {θ}_{k} ) + {r}_{k}^{2} {cos}^{2} ( {θ}_{k} ) {σ}_{{θ}_{k}}^{2}\end{matrix} ]$$

Threat Assessment and Prioritization. As the updated data for each track are sent to the IC 115 every processing cycle, the perception engine 120 maintains a list of tracks and their data and autonomously analyzes each track over time to estimate the likelihood that the track is conducting a behavior consistent with that of a pirate vessel or other threatening behavior. The IC 115 may use a fuzzy inferencing technique called a Continuous Inferencing Network (CINet) to perform this assessment. However, any number of probabilistic or statistical methodologies can be used for this assessment, including but not limited to Bayesian Belief Networks, evidential reasoning (e.g., Dempster-Shafer), spatio-temporal reasoning (e.g., qualitative trajectory calculus), and model-free classifiers (e.g., neural networks). CINets provide a data-to-outcome tree that can be visualized as a decision tree, but each junction in the tree is assessed not via traditional logic but rather via fuzzy logic. Thus, the outcome may not be measured in Boolean terms (true/false) but as a confidence factor (CF) between 0.0 and 1.0, inclusive, such that a CF of 0.0 could be interpreted as “absolutely false” and 1.0 as “absolutely true.” In this fashion, each track is scored and compared to a preconfigured threshold. The tracks are also ranked by CF. Once the CF exceeds the threshold, such as 0.7, it is classified as a threat.

In certain embodiments, a threatening behavior referred to as a “Suspicious Closing CINet” can be assessed with threat analyzer 122. Threat analyzer assesses the track's range, bearing, speed, heading, and other data to compute the CF that the vessel is attempting to intercept the protected ship. The intent of the vessel's course may be measured in two ways. The CF rises as the heading of the track approaches its reciprocal bearing (that is, the vessel being assessed is keeping its bow roughly pointed at the protected ship). While this is not technically an intercept course (since it leads to an arcing pattern in order to continue to close in on the prey), it is a method often observed (presumably because it is easier to execute than plotting the most direct intercept course). However, in case an attacking vessel does attempt to plot a traditional intercept course, the CF also rises as the Closest Point of Approach (CPA) approaches zero (which would be an exact collision course) while the Time to CPA is consistent with the contact's range and speed and is falling. It is this latter part of the assessment that forms the foundation for the collision warning capability discussed herein. The range and speed are used more indirectly to help prioritize multiple threats such that closer ones and faster ones score higher CFs.

Certain embodiments may also have another behavior referred to as “Shadowing CINet,” which is included as a warning or precursor. The threat analyzer 122 assesses the track's range and bearing averaged over a period of time. The more that both of these parameters remain constant, the higher the CF that the track is tailing the protected ship, which can be a threatening action. A Shadowing Threat will cause the track to be highlighted and brought to the attention of the crew via the user interface 132, but the only countermeasure invoked is following it with the camera mounted on the countermeasure suite. Such countermeasure may not be invoked in this manner if there is no suspicious closing threat identified.

Additional threat behavior CINets contemplated include, but are not limited to hiving, where the origin of one or more tracks align with the location of a pre-existing track, and probing, where the track closes, but then backs off. Other CINet-based threat behavior assessments are possible.

Field Test Results. To tune and validate the track formation and threat assessment algorithms, as well as the radar tuning, a series of in-water field tests were conducted.

During these field tests, tracks were consistently formed for real objects while consistently not forming tracks for noise, clutter, and land masses, if present. When false tracks were formed, they did not persist long enough to be of concern. For contacts entering from outside the outer range of the radar 102 (which was set to 1.8 nautical miles for these tests), tracks were typically formed by the time the contact reached a range of about 1.4 nm, depending on speed, clutter level, and radar cross section. Once formed, tracks leaving the area could be maintained until the contact exceeded the range set for the radar 102.

Likewise, the threat analyzer 122 consistently classified the test boats as threats, typically within three sweeps of the initiation of the threatening behavior. This includes attempts by the pirate actors to elude and evade being locked on to by the system (e.g., pursuing an S-shaped path during the attack).

FIG. 5 shows a screen capture of the user interface 132 depicting an active threat in the presence of 2 benign tracks in the scene. Track data is tabulated in the upper left hand corner with video displayed below it. The right half of the screen superimposes the track (white) and threat (red) icons over the radar contact data (varying shades of green). Ownship is at the center, with ownship data displayed in the upper left-hand corner of the radar window.

System 100 will be able to consistently and reliably detect, track, estimate the threat level of vessels of the type typically used by maritime pirates, and execute a response to those tracks that are deemed to be a threat. The ability to perform this feat autonomously is due to system core 108. The ability to accomplish this using a radar sensor costing orders of magnitude less than typical military-grade radars means that the system can serve as a piracy deterrent at a price-point that is viable for the international shipping industry.

In certain embodiments, the system 100 may incorporate the use of a communications network, such as communications network 135. The communications network 135 of the system 100 may be configured to link each of the devices in the system 100 to one another, and may be configured to transmit, generate, and receive any information and data traversing the system 100. In one embodiment, the communications network 135 may include any number of servers or other computing devices. The communications network 135 may include a hypertext-transfer protocol (HTTP) enabled network, a wireless network, an ethernet network, a satellite network, a broadband network, a cellular network, a private network, a cable network, the Internet, an internet protocol network, any other type of network or telecommunications medium, or any combination thereof. In certain embodiments, the communications network 135 may be located in a selected geographic region, or may span several geographic regions. Other embodiments may include the incorporation of serial connections between components including but not limited to USB and RS-232 protocols.

The database 155 of the system 100 may be utilized to store and relay information that traverses the system 100, store content that traverses the system 100, store data about each of the devices in the system 100, and perform any other typical functions of a database. In one embodiment, the database 155 may be connected to or reside within the communications network 135. Additionally, the database 155 may include a processor and memory or be connected to a processor and memory to perform the various operation associated with the database 155. In certain embodiments, the database 155 may be connected to the radar 102, the motion sensor 104, the core 108, the data processing module 110, the track processing module 112, the IC 115, the pan-tilt device 128, the spotlight 130, the camera 134, the user interface 132, the server 160, or to any other device used in the system. The database 155 may also store information associated with the system 100 such as, but not limited to, contact information, information about each track, confidence level information, countermeasure information, data identifying threats, video data, audio data, radar data, or any other data described herein or otherwise. Furthermore, the database 155 may be configured to process queries sent to it by any of the devices in the system 100. Other embodiments may include database functionality achieved through other means, including but not limited to flat files, text files, spreadsheets, messages and even the file system provided by a computer's native operating system.

Notably, the system 100 may perform any of the operative functions disclosed herein by utilizing the processing capabilities of server 160, the storage capacity of the database 155, or any other component of the system 100 to perform the operative functions disclosed herein. The server 160 may include one or more processors 162 that may be configured to process any of the various functions of the system 100. The processors 162 may be software, hardware, or a combination of hardware and software. Additionally, the server 160 may also include a memory 161, which stores instructions that the processors 162 may execute to perform various operations of the system 100. For example, the server 160 may assist in processing loads handled by the various devices in the system 100, such as, but not limited to, obtaining information relating to the contacts, transforming the contact data into tracks, analyzing the track data, computing confidence levels, employing countermeasures, determining trajectories, generating a data and video archive, and performing any other suitable operations conducted in the system 100 or otherwise. In one embodiment, multiple servers 160 may be utilized to process the functions of the system 100. The server 160 and other devices in the system 100, may utilize the database 155 for storing data about the devices in the system 100 or any other information that is associated with the system 100. In one embodiment, multiple databases 155 may be utilized to store data in the system 100.

Although FIG. 1 illustrates a specific example configuration of the various components of the system 100, the system 100 may include any configuration of the components, which may include using a greater or lesser number of the components. For example, the system 100 is illustratively shown as including a radar 102, a motion sensor 104, a core 108, a data processing module 110, a track processing module 112, an IC 115, an input interface 118, a perception engine 120, a threat analyzer 122, a response engine 124, a response interface 126 for countermeasure actions, a pan-tilt device 128, a spotlight 130, a user interface 132, a camera 134, a database 155, and a server 160. However, as shown in FIG. 2, the system 100 may include multiple radars 102, motion sensors 104, cores 108, data processing modules 110, track processing modules 112, ICs 115, input interfaces 118, perception engines 120, threat analyzers 122, response engines 124, response interfaces 126 for countermeasure actions, pan-tilt devices 128, spotlights 130, user interface(s) 132, cameras 134, databases 155, and servers 160, or any number of any of the other components in the system 100. Furthermore, in one embodiment, substantial portions of the functionality and operations of the system 100 may be performed by other networks, computing resources, and systems that may be connected to system 100.

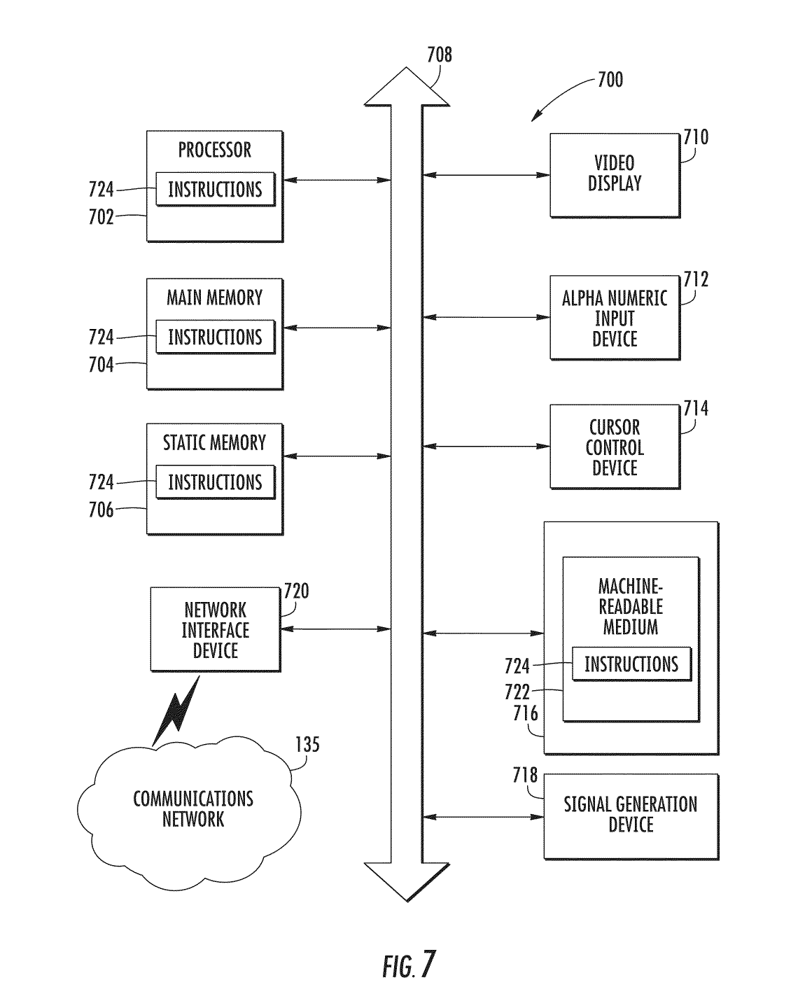

As shown in FIG. 6, an exemplary method 600 for providing autonomous robotic mobile threat security is schematically illustrated, and may include, at step 602, receiving information associated with an environment surrounding an object. The information may include information associated with a contact. In certain embodiments, the information may be received from the radar 102, the motion sensor 104, any combination thereof, or by any other appropriate device or source of data. At step 604, the method 600 may include transforming the information into track data. In certain embodiments, the track data may correspond to one or more tracks associated with the contact. In certain embodiments, the transformation may be performed by the track processing module 112 or by any other appropriate device, method or process. At step 606, the method 600 may include computing, based on the track data accumulated over time, confidence levels for any number of behaviors for each track. Each confidence level may be utilized to indicate a level of threatening behavior exhibited by each contact. In certain embodiments, the computing of the confidence level may be performed with the IC 115, the system core 108, the server 160, or by any other appropriate device.

At step 608, the method 600 may include determining if any confidence level for each track is at least as great as a threshold confidence level for that behavior. In certain embodiments, the determining may be conducted with the IC 115, the system core 108, the server 160, or by any other appropriate device. The method 600 may include, at step 610, taking no further action for those tracks having all confidence levels that are not at least as great as the corresponding threshold confidence levels. In such a scenario, the method 600 may include continuing to monitor the environment and receive information associated with the contact. However, for each track that is determined to have at least one confidence level at least as great as the corresponding threshold confidence level, the method 600 may include, at step 612, classifying each of these tracks as a threat. In certain embodiments, the classification may be performed with the IC 115, the system core 108, the server 160, or by any other appropriate device.

At step 614, the method 600 may include employing a countermeasure against the threat. In certain embodiments, the employing of the countermeasure may be performed with the IC 115, the system core 108, the server 160, or by any other appropriate device. At step 616, the method 600 may include transmitting a notification and/or alert regarding the threat. The notification and/or alert may be transmitted to any person or device that would benefit from knowing of the threat. In certain embodiments, the notification and/or alert may be transmitted with the IC 115, the system core 108, the server 160, or by any other appropriate device. At step 618, the method 600 may include initiating the archiving of data and media content associated with the threat. In certain embodiments, the media content may be video, audio, or other types of content. In certain embodiments, the initiating of the archiving of the data and media content may be triggered with the IC 115, the system core 108, the server 160, or by any other appropriate device. Notably, the method 600 may incorporate any of the functionality described herein for the system 100, and is not intended to be limited to the disclosure provided herewith.

Notably, the system 100 and methods disclosed herein are not intended to be limited to detecting piracy-related threats and employing countermeasures against piracy-related threats. In certain embodiments, the system 100 and methods may be configured for detecting any potential collisions and employing countermeasures against any potential collisions, detecting any type of contact and employing countermeasures against any type of contact, or any combination thereof.

Referring now also to FIG. 7, at least a portion of the methodologies and techniques described with respect to the exemplary embodiments of the system 100 can incorporate a machine, such as, but not limited to, computer system 700, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100.

In some embodiments, the machine may operate as a standalone device. In some embodiments, the machine may be connected to (e.g., using communications network 135, another network, or a combination thereof) and assist with operations performed by other machines, such as, but not limited to, the radar 102, the motion sensor 104, the cores 108, the data processing module 110, the track processing module 112, the switches 114, the IC 115, the pan-tilt device 128, the spotlight 130, the camera 134, the database 155, the server 160, or any combination thereof. The machine may be connected with any component in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU), or both, a main memory 704 and a static memory 706, which communicate with each other via a bus 708. The computer system 700 may further include a video display unit 710, which may be, but is not limited to, a liquid crystal display (LCD), a flat panel, a solid state display, or a cathode ray tube (CRT). The computer system 700 may include an input device 712, such as, but not limited to, a keyboard, a cursor control device 714, such as, but not limited to, a mouse, a trackball or a touch screen, a disk drive unit 716, a signal generation device 718, such as, but not limited to, a speaker or remote control, and a network interface device 720. A serial interface device that connects to one or more serial devices via a serial protocol such as, but not limited to, Universal Serial Bus (USB) or IEEE RS-232, may be used.

The disk drive unit 716 may include a machine-readable medium 722 on which is stored one or more sets of instructions 724, such as, but not limited to, software embodying any one or more of the methodologies, processes or functions described herein, including those methods illustrated above. The instructions 724 may also reside, completely or at least partially, within the main memory 704, the static memory 706, or within the processor 702, or a combination thereof, during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium 722 containing instructions 724 so that a device connected to the communications network 135, other network, or both, can send or receive voice, video or data, and to communicate over the communications network 135, other network, or both, using the instructions. The instructions 724 may further be transmitted or received over the communications network 135, other network, or both, via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The terms “machine-readable medium” or “machine-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium” or “machine-readable device” may be non-transitory. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

We claim:

1. A system for providing autonomous robotic mobile threat security, the system comprising:
a memory that stores instructions;
a processor that executes the instructions to perform operations, the operations comprising:
receiving sensor information associated with an environment surrounding an object, wherein the sensor information is associated with a contact;
transforming the contact information into track data corresponding to a track associated with the contact;
computing, based on the track data, a confidence level for the track, wherein the confidence level indicates a representation of the degree to which a threatening behavior is exhibited by the contact as indicated by the track;
determining if the confidence level for the track is at least as great as a threshold confidence level;
classifying the track as a threat if the confidence level is determined to be at least as great as the threshold confidence level; and
employing a countermeasures against the threat.

2. The system of claim 1, wherein the track data comprises range data, bearing data, speed data, heading data, a predicted closest point of approach, a time to closest point of approach, the confidence level, or any combination thereof.

3. The system of claim 1, wherein the operations further comprise not employing the countermeasure against the threat if the confidence level computed is less than the threshold confidence level.

4. The system of claim 1, wherein the operations further comprise disrupting threatening behavior conducted by the threat by utilizing the countermeasure.

5. The system of claim 1, wherein the operations further comprise determining a trajectory of the every track based on the track data.

6. The system of claim 5, wherein employing the countermeasure further comprises adjusting a pan-tilt device in accordance with the trajectory of the threat such that any countermeasure mounted on the pan-tilt device remains pointed at the threat.

7. The system of claim 6, wherein the operations further comprise sensing motion of the object in six degrees of freedom to further adjust the pan-tilt device such that any countermeasure mounted on the pantilt device remains pointed at the threat despite the motion of the object.

8. The system of claim 1, wherein the operations further comprise providing instructions for causing a graphical user interface to display the track data, visual/iconic track information, media content, data or visual information that is associated with the threat, configuration settings, a status of the system and components of the system, or any combination thereof.

9. The system of claim 1, wherein the operations further comprise storing the information, the track data, information associated with the countermeasure, information associated with the threat, or any combination thereof using a non-volatile data storage medium.

10. The system of claim 1, wherein the operations further comprise providing an option for users to upgrade or downgrade a system-determined threat level posed by the track.

11. A method for providing autonomous robotic mobile threat security, the system comprising:
receiving sensor information associated with an environment surrounding an object, wherein the sensor information is associated with a contact;
transforming the contact information into track data corresponding to a track associated with the contact;
computing, based on the track data, a confidence level for the track, wherein the confidence level indicates a representation of the degree to which a threatening behavior is exhibited by the contact as indicated by the track;
determining, by utilizing instructions from memory that are executed by a processor, if the confidence level for the track is at least as great as a threshold confidence level;
classifying the track as a threat if the confidence level is determined to be at least as great as the threshold confidence level; and
employing a countermeasure against the threat.

12. The method of claim 11, wherein the track data comprises range data, bearing data, speed data, heading data, a predicted closest point of approach, a time to closest point of approach, the confidence level, or any combination thereof.

13. The method of claim 11, further comprising not employing the countermeasure against the threat if the confidence level computed is less than the threshold confidence level.

14. The method of claim 11, further comprising disrupting threatening behavior conducted by the threat by utilizing the countermeasure.

15. The method of claim 11, further comprising determining a trajectory of the track based on the track data.

16. The method of claim 15, wherein employing the countermeasure further comprises adjusting a pan-tilt device in accordance with the trajectory of the threat such that any countermeasure mounted on the pan-tilt device remains pointed at the threat.

17. The method of claim 16, further comprising sensing motion of the object in six degrees of freedom to further adjust the pan-tilt device such that any countermeasure mounted on the pan-tilt device remains pointed at the threat despite the motion of the object.

18. The method of claim 11, further comprising providing instructions for causing a graphical user interface to display the track data, visual/iconic track information, media content, data or visual information that is associated with the threat, configuration settings, a status of the system and components of the system, or any combination thereof.

19. The method of claim 11, further comprising storing the information, the track data, information associated with the countermeasure, information associated with the threat, or any combination thereof using a non-volatile data storage medium.

20. The method of claim 11, further comprising providing an option for users to upgrade or downgrade a system-determined threat level posed by the track.

21. A computer-readable device comprising instructions, which, when loaded and executed by a processor, cause the processor to perform operations comprising:
receiving sensor information associated with an environment surrounding an object, wherein the sensor information is associated with a contact;
transforming the contact information into track data corresponding to a track associated with the contact;
computing, based on the track data, a confidence level for the track, wherein the confidence level indicates a representation of the degree to which a threatening behavior exhibited is by the contact as indicated by the track;
determining if the confidence level for the track is at least as great as a threshold confidence level;
classifying the track as a threat if the confidence level is determined to be at least as great as the threshold confidence level; and
employing a countermeasure against the threat.

22. A system for providing autonomous robotic mobile threat security, the system comprising:
a memory that stores instructions;
a processor that executes the instructions to perform operations, the operations comprising:
receiving sensor information associated with an environment surrounding an object, wherein the sensor information is associated with a contact;
transforming the contact information into track data corresponding to a track associated with the contact;
computing, based on the track data, a confidence level for the track, wherein the confidence level indicates a representation of the degree to which a threatening behavior is exhibited by the contact as indicated by the track;
determining if the confidence level for the track is at least as great as a threshold confidence level; and
classifying the track as a threat if the confidence level is determined to be at least as great as the threshold confidence level.
